(19) United States
(12) Patent Application Publication
(10) Pub. No.: US 2011/0311192 A1
(43) Pub. Date: Dec. 22, 2011

(54) OPTICAL WAVEGUIDE DEVICE AND MANUFACTURING METHOD OF OPTICAL WAVEGUIDE DEVICE

(76) Inventor: SHINYA WATANABE, Tokyo (JP)

(21) Appl. No.: 13/103,901

(22) Filed: May 9, 2011

(30) Foreign Application Priority Data
Jun. 22, 2010 (JP) 141236/2010

(51) Int. Cl. G02B 6/036; G02B 6/132

(52) U.S. Cl. 385/129; 427/163.2

(57) ABSTRACT

An optical waveguide device includes a lower clad layer formed on a substrate, an optical waveguide core formed on the lower clad layer, at least one pair of banks arranged in rows along the optical waveguide core which is arranged between each pair of the banks, and an upper clad layer covering the optical waveguide core and the banks.

This application is based upon and claims the benefit of priority from Japanese Patent Application No. 2010-141236, filed on Jun. 22, 2010, the disclosure of which is incorporated herein in its entirety by reference.

### TECHNICAL FIELD

The present invention relates to an optical waveguide device, and more particularly, to an optical waveguide device which can reduce a fluctuation of an optical path length and a double refractive index.

### BACKGROUND ART

In manufacturing an optical waveguide device such as an optical switch and an optical modulator used in an optical communication system, PLC (Planar Lightwave Circuit) technology which facilitates integration and mass production is effective. PLC technology is a technology for forming microscopic optical waveguides on a substrate by same microfabrication technology for semiconductor integrated circuit manufacturing process. Specifically, for example, as shown in FIG. 4A, first, a silicon oxide film whose refractive index is low is formed as a lower clad layer 22 on a silicon substrate 21, and next, as shown in FIG. 4B, on the lower clad layer 22, a silicon oxide film 23 whose refractive index is high is laminated. After that, by photolithography technology, the high refractive index silicon oxide film 23 is patterned as an optical waveguide core as shown in FIG. 4C. Further, as shown in FIG. 4D, a low refractive index silicon oxide film which becomes an upper clad layer 24 is laminated, and, as shown in FIG. 4E, it is reflowed by heat treatment. In addition, the refractive index of a silicon oxide film can be set arbitrarily by doping of phosphorus, boron, germanium, and so on. By the above procedure, optical waveguides with various shapes can be formed on a substrate.

Among optical waveguide devices, interferometers using optical waveguides are generally applied to and used in variety of optical communication devices. FIG. 5 indicates the optical waveguide structure of Mach-Zehnder interferometer which is a basic interferometer. Two optical waveguides 25 and 26 of which an interferometer is composed are different in the length between two directional coupler parts. FIG. 6 indicates a general optical waveguide structure of 90-degree optical hybrid interferometer for retrieving phase information from polarized lights into which a light signal is separated. In this device, two optical waveguide arms 27 and 28 which branches an optical signal have equal optical path lengths, and between two optical waveguide arms 29 and 30 which branch local oscillation light, the optical path length of optical waveguide arm 30 is longer than that of the optical waveguide arm 29 by λ/(4n). Here, n is the equivalent refractive index of the optical waveguide and λ is the wavelength of the light signal.

In particular in production of the interferometer devices mentioned above, the respective optical path lengths need to be controlled very accurately. However, in actual production process, effective value of the optical path length may deviate from its design value.

Optical path length is determined from the equivalent refractive index and the physical length of the optical waveguide. Here, the physical length of optical waveguide is determined by accuracy of patterning of the optical waveguide core pattern drawn on a photomask, and it can be controlled sufficiently by the current level of the photolithography techniques. On the other hand, the equivalent refractive index of optical waveguide fluctuates due to various disturbances at production processes, and it can be a factor of an optical path length fluctuation.

As a main factor which causes such equivalent refractive index fluctuation, there is a film stress that occurs during heat treatment of the upper clad layer. For example, as shown in FIG. 4E, optical waveguide core is generally formed by reflowing the upper clad layer 24 laminated on the optical waveguide core, at a high temperature to embed the core in the clad layer. Here, when reflowing by heat treatment, the upper clad layer 24 tends to minimize its surface area so that it becomes stable in terms of dynamics. The optical waveguide core 23 is under stress caused by the reflowing. When the stress from the upper clad layer is strong, the optical characteristics of the optical waveguide core changes and a double refraction is induced, and as a result, the equivalent refractive index of the optical waveguide fluctuates.

Also, if the softening temperature of the optical waveguide core material is not higher sufficiently than the treatment temperature in the heat treatment process, the optical waveguide core may be transformed. Since small size optical waveguide devices are strongly demanded, curve sections of optical waveguides have to be drawn with small radius. Accordingly, the refractive indexes of core and clad need to be made much different each other so that bending loss may not occur. In order to achieve this, in general, concentration of impurity doped to the core material is raised to heighten the refractive index of the core. Germanium and phosphorus which are the typical impurities doped for the purpose of improving the refractive index have also the effect that they lower the softening temperature of the core material. Therefore, if the hardness of the optical waveguide core 23 cannot be kept sufficiently at the heat treatment temperature of the upper clad layer 24, the optical waveguide core 23 transforms as shown in FIG. 7A by stresses (indicated by arrows) caused by reflow of the upper clad layer 24, consequently its equivalent refractive index fluctuates.

For example, when the upper clad layer softens and flows by heat treatment, the core is transformed by stresses of pulling the core to the flow directions of the upper clad. At that time, as shown in FIG. 7A, if the waveguide core is isolated from other optical waveguides substantially, approximately bilaterally symmetric stresses are added to the optical waveguide core from both sides, and as a result it will be transformed approximately bilaterally symmetrically. Also, such stresses cause double refraction to the optical waveguide core.

On the other hand, as shown in FIG. 7B, if another optical waveguide core or the like is arranged around the optical waveguide core, stresses applying to each of them from the upper clad layer are not generated equally in the left and right directions as indicated by the arrows. The side where another waveguide is not arranged, or the side with a far distance from another waveguide, is subjected to a larger force and the optical waveguide core transforms toward that direction. In the case of this figure, the optical waveguide core and another one are strongly pulled to the direction departing from each other, and transformation and double refraction of the optical waveguide cores is caused.

Thus, the amounts of transformation and double refraction which occurs to the optical waveguide core differ depending on positional relationships among optical waveguide cores. For example, in the structure such as the Mach-Zehnder interferometer of FIG. 5, the stress from the upper clad layer applied to the optical waveguide cores 25 and 26 to which an optical path length difference has been given is influenced by mutual existence of the optical waveguide cores. In this case, if the pair of the optical waveguide cores 25 and 26 is isolated from other optical waveguides, although the directions of transformation of them are different as shown in the FIG. 7B, the amounts of the transformation and the double refraction indexes become almost the same level. As a result, there is almost no variation in the relative optical path length difference. However, because an optical waveguide device is configured in order to realize various functions generally, there are few cases that only these two optical waveguide cores are isolated substantially or are arranged at a regular interval from other optical waveguide cores. For this reason, according to a positional relationship between an optical waveguide core and other optical waveguide cores around it, the stress added to the optical waveguide core and the direction and the amount of transformation caused by such stress are altered. That is, the fluctuation in the equivalent refractive index which occurs to the optical waveguide will vary according to the layout of the optical waveguide core in a whole optical waveguide device. Because the amount of this variation is influenced by manufacturing disturbance factors, it is difficult to estimate it correctly in advance, thus it causes manufacturing yield deterioration.

A technology for coping with such problem is disclosed, for example, in Japanese Patent Application Laid-Open No. 2003-315573 (hereinafter, referred to as “patent document 1”). The technology described in patent document 1 has the structure in which, as shown in FIG. 8, when the optical waveguide core 23 is formed from the film of the optical waveguide core layer, only the neighborhood parts along the optical waveguide core 23 are removed and peripheral areas 31 besides those are left. As a result, since the region of the upper clad layer 24 that applies a stress to the optical waveguide core 23 decreases, the stress to the optical waveguide core 23 decreases substantially, and thus it is possible to prevent transformation of the optical waveguide core 23 effectively.

### SUMMARY

An exemplary object of the present invention is to provide an optical waveguide device which enables the stresses from the periphery and the substrate to an optical waveguide core to be reduced, and the fluctuation of an optical path length caused by transformation or double-refractive-index change of the optical waveguide core to be suppressed.

An optical waveguide device according to an exemplary aspect of the invention includes a lower clad layer formed on a substrate, an optical waveguide core formed on the lower clad layer, at least one pair of banks arranged in rows along the optical waveguide core which is arranged between each pair of the banks, and an upper clad layer covering the optical waveguide core and the banks.

And a manufacturing method of an optical waveguide device according to another exemplary aspect of the invention includes forming a lower clad layer on a substrate, forming an optical waveguide core and at least one pair of banks arranged in rows along the optical waveguide core which is arranged between each pair of the banks, on the lower clad layer, and forming an upper clad layer covering the optical waveguide core and the banks.

### BRIEF DESCRIPTION OF THE DRAWINGS

Exemplary features and advantages of the present invention will become apparent from the following detailed description when taken with the accompanying drawings in which:

FIG. 1A is a top view showing an optical waveguide device structure of a first and a second embodiment of the present invention;

FIG. 1B is a sectional view showing an optical waveguide device structure of a first and a second embodiment of the present invention;

FIG. 2 is a top view showing an optical waveguide device structure of a third embodiment of the present invention;

FIG. 3 is a top view showing an optical waveguide device structure of a fourth embodiment of the present invention;

FIG. 4A is a first sectional view showing an optical waveguide device under fabrication of by PLC technology;

FIG. 4B is a second sectional view showing an optical waveguide device under fabrication of by PLC technology;

FIG. 4C is a third sectional view showing an optical waveguide device under fabrication of by PLC technology;

FIG. 4D is a fourth sectional view showing an optical waveguide device under fabrication of by PLC technology;

FIG. 4E is a fifth sectional view showing an optical waveguide device under fabrication of by PLC technology;

FIG. 5 is a top view showing a structure of a Mach-Zehnder interferometer;

FIG. 6 is a top view showing a structure of a 90-degree optical hybrid interferometer;

FIG. 7A is a sectional view showing an optical waveguide core of a general structure with stresses being applied;

FIG. 7B is a sectional view showing two optical waveguide cores of a general structure with stresses being applied;

FIG. 8 is a sectional view showing an inhibiting effect for the stress which is applied to an optical waveguide core in patent document 1; and

FIG. 9 is a sectional view showing the stress which an optical waveguide core is actually subjected to in patent document 1.

### EXEMPLARY EMBODIMENT

Next, exemplary embodiments of the present invention will be described with reference to drawings.

### The First Embodiment

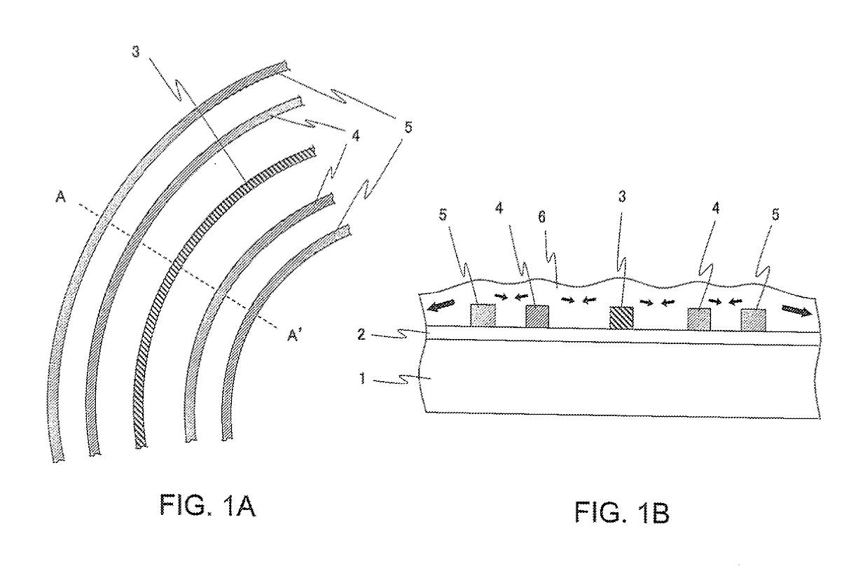

FIG. 1A is a top view showing an optical waveguide device structure of a first embodiment of the present invention. FIG. 1B is a sectional view taken in line A-A′ of FIG. 1A. Referring to FIGS. 1A and 1B, lower clad layer 2 is formed on substrate 1. And optical waveguide core 3 is formed on the lower clad layer 2.

This optical waveguide device includes at least one pair of banks arranged in rows along optical waveguide core 3 which is arranged between each pair of the banks. In this embodiment, two pairs of banks 4, 5 arranged in rows along the optical waveguide core 3, and the optical waveguide core 3 is arranged between each pair of the banks 4, 5.

Further, upper clad layer 6 covers the optical waveguide core 3 and the banks 4, 5. In this waveguide as shown in FIG. 1B, in the heat treatment, flow of the upper clad layer 6 covering the optical waveguide core 3 is held back by the banks 4, 5. Accordingly, a stress inflicted on the optical waveguide core 3, and transformation and double refraction associated with that are not influenced by other optical waveguide cores which exist in the neighborhood, and are kept almost constant in the transmission direction of light.

Further, because respective banks 4, 5 have wall-like structure, the area that contacts with the lower clad layer 2 and the upper clad layer 6 is limited. For this reason, a stress caused by the thermal expansion coefficient difference between the film constituting the banks 4, 5 or the optical waveguide core 3 and the substrate 1 is very small.

In addition, because the volumes of the banks 4, 5 themselves are limited, the influence of the stress caused by the thermal expansion of the banks 4, 5 themselves to the optical waveguide core 3 is very small.

As described above, in this embodiment, since the stresses applied to the optical waveguide core 3 from the periphery and the substrate 1 are reduced, transformation of the optical waveguide core 3 and fluctuation in double refractive index become hard to generate. For this reason, a fluctuation of optical path length can be suppressed effectively.

In FIGS. 1A and 1B, an example where two banks are provided in each side of the optical waveguide core 3 has been shown. However, even by the structure in which one bank is provided in each side of the optical waveguide core 3, and the structure in which three or more banks are provided in each side of the optical waveguide core 3, the basically similar effect can be obtained. However, as the number of banks is increased, flow of upper clad layer is easy to be equalized and thus it is preferred.

### The Second Embodiment

According to a second embodiment of the present invention, in FIGS. 1A and 1B, the widths of banks 4 arranged in both sides of optical waveguide core 3 forming a pair are made to be equal each other, and the intervals between each of banks 4 and the optical waveguide core 3 are made to be equal each other. Similarly, the widths of banks 5 and the intervals between banks 5 and optical waveguide core 3 are also set to be equal each other.

In the second embodiment, as a result of adopting a structure in which both banks 4 and 5 are arranged in both sides of the optical waveguide core 3 symmetrically as above, it is possible to effectively prevent a stress applied to the optical waveguide core 3 from being biased toward one side, by a relatively simple design.

### The Third Embodiment

According to the third embodiment of a present invention, in FIGS. 1A, 1B, all the widths of optical waveguide core 3 and the banks 4, 5 arranged in both sides of the optical waveguide core 3 are made to be equal, and also the intervals between any neighboring two of them are made equal.

According to the third embodiment, because flow of a part of upper clad layer 24 that covers the optical waveguide core 3 and banks arranged in its both sides can be equalized suitably, it is possible to disperse stresses around the optical. waveguide core 3 effectively and suppress partiality of the stresses.

### The Fourth Embodiment

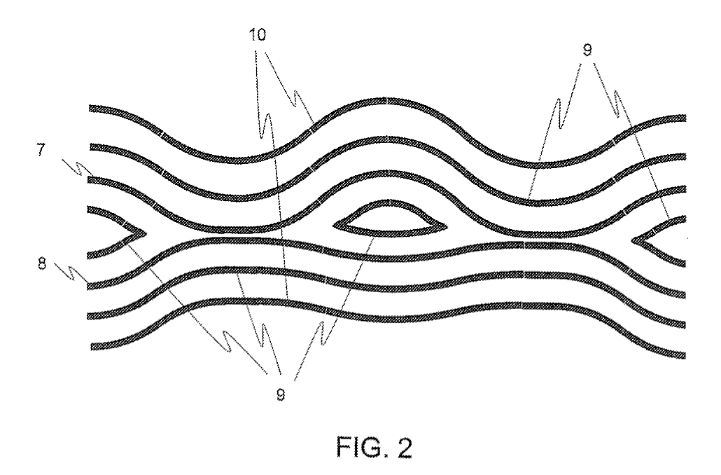

FIG. 2 is a top view of a Mach-Zehnder interferometer according to a fourth embodiment of the present invention. This Mach-Zehnder interferometer has optical waveguide cores 7, 8. In both sides of each of the optical waveguide cores 7, 8, first banks 9 are formed, and second banks 10 are further formed outside the first banks 9.

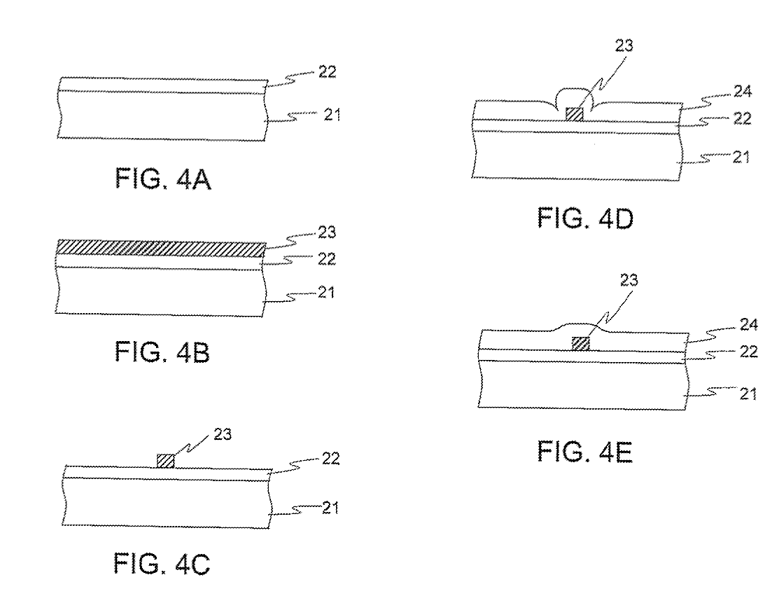

A Mach-Zehnder interferometer of the structure shown in FIG. 2 can be produced by the following procedure of general PLC technology indicated in FIG. 4A-E. For example, on silicon substrate 21, low refractive index silicon oxide film 22 which becomes lower clad layer is formed by chemical vapor deposition method by 10 (m of thickness. Next, high refractive index silicon oxide film 23 which becomes optical waveguide core layer is laminated by 5 (m of thickness. After that, high refractive index silicon oxide film 23 is patterned as optical waveguide cores 7, 8 by photolithography method. First banks 9 and second banks 10 are formed also by patterning high refractive index silicon oxide film 23. Here, it is supposed that the widths of the waveguide cores 7, 8, the first banks 9 and the second banks 10 are all 5 (m, for example. Then, low refractive index silicon oxide film which becomes upper clad layer 24 is laminated by 10 (m of thickness, and then reflowed by heat treatment. By this, the waveguide cores 7, 8, the first banks 9 and the second banks 10 are covered. A predetermined optical waveguide is completed by this.

Meanwhile, each of the optical waveguide cores 7, 8 and the first banks 9 are arranged such that the intervals between them are both 100 μm, for example. This interval is determined so that transmitting light does not cause coupling between the waveguide cores 7 and 8 and the first banks 9, and, at the same time, the flatness of the upper clad layer 24 is obtained. The first banks 9 and the second banks 10 are arranged such that the interval between them is also 100 μum.

According to this embodiment, in an optical waveguide device including combination of a plurality of optical waveguides, stresses applied to respective optical waveguide cores can be reduced. Further, by forming optical waveguide cores and the banks simultaneously, the process can be simplified.

### The Fifth Embodiment

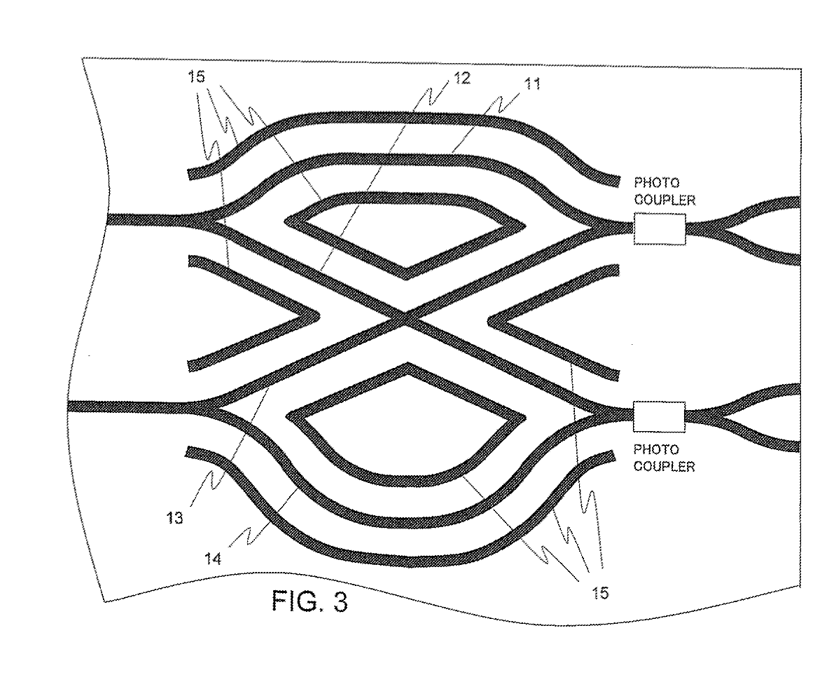

FIG. 3 is a top view of a 90-degree optical hybrid interferometer according to a fifth embodiment of the present invention. Banks 15 are provided in both sides of respective optical waveguide arms 11-14 which constitute this 90-degree optical hybrid interferometer.

A manufacturing method of the 90-degree optical hybrid interferometer shown in FIG. 3 is similar to that of the second embodiment.

According to this embodiment, banks are provided at only both sides of portions of optical waveguide cores for which fluctuation of optical path length and increase of double refractive index need to be suppressed particularly strictly. By making the structure as above, the layout of banks can be simplified.

The whole or part of the exemplary embodiments disclosed above can be described as, but not limited to, the following supplementary notes.

(Supplementary note 1)

An optical waveguide device comprising:

a lower clad layer formed on a substrate;

an optical waveguide core formed on said lower clad layer;

at least one pair of banks arranged in rows along said optical waveguide core which is arranged between each pair of said banks; and

an upper clad layer covering said optical waveguide core and said banks.

(Supplementary note 2)

The optical waveguide device according to supplementary note 1, wherein each pair of said banks has equal widths and equal distances from said optical waveguide core.

(Supplementary note 3)

The optical waveguide device according to supplementary note 1 or 2, wherein all of said banks and said optical waveguide core have equal widths and equal intervals.

(Supplementary note 4)

The optical waveguide device according to any one of supplementary notes 1 to 3, wherein said banks and said optical waveguide core are formed from the same layer.

(Supplementary note 5)

The optical waveguide device according to any one of supplementary notes 1 to 4, wherein said banks are separated from said optical waveguide core at least at a distance which does not cause a coupling of light traveling along said optical waveguide core.

(Supplementary note 6)

A manufacturing method of an optical waveguide device, comprising:

forming a lower clad layer on a substrate;

forming an optical waveguide core and at least one pair of banks arranged in rows along said optical waveguide core which is arranged between each pair of said banks, on said lower clad layer; and

forming an upper clad layer covering said optical waveguide core and said banks.

(Supplementary note 7)

The manufacturing method of an optical waveguide device according to supplementary note 6, wherein each pair of said banks has equal widths and equal distances from said optical waveguide core.

(Supplementary note 8)

The manufacturing method of an optical waveguide device according to supplementary note 6 or 7, wherein all of said banks and said optical waveguide core have equal widths and equal intervals.

(Supplementary note 9)

The manufacturing method of an optical waveguide device according to any one of supplementary notes 6 to 8, wherein said banks and said optical waveguide core are formed from the same layer.

(Supplementary note 10)

The manufacturing method of an optical waveguide device according to any one of supplementary notes 6 to 9, wherein said banks are separated from said optical waveguide core at least at a distance which does not cause a coupling of light traveling along said optical waveguide core.

The technology described in patent the document 1 mentioned above can reduce a stress from upper clad layer which covers optical waveguide core part. However, there have been the following problems in this technology.

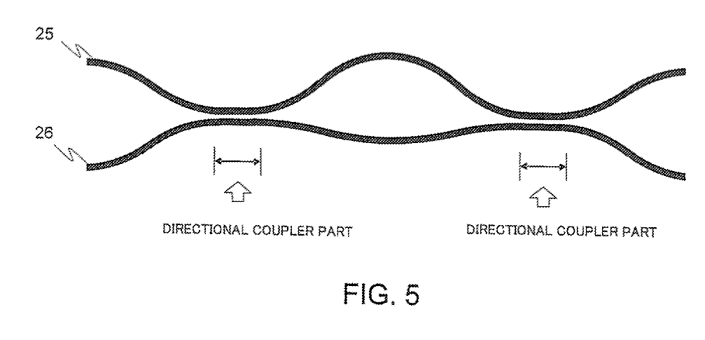

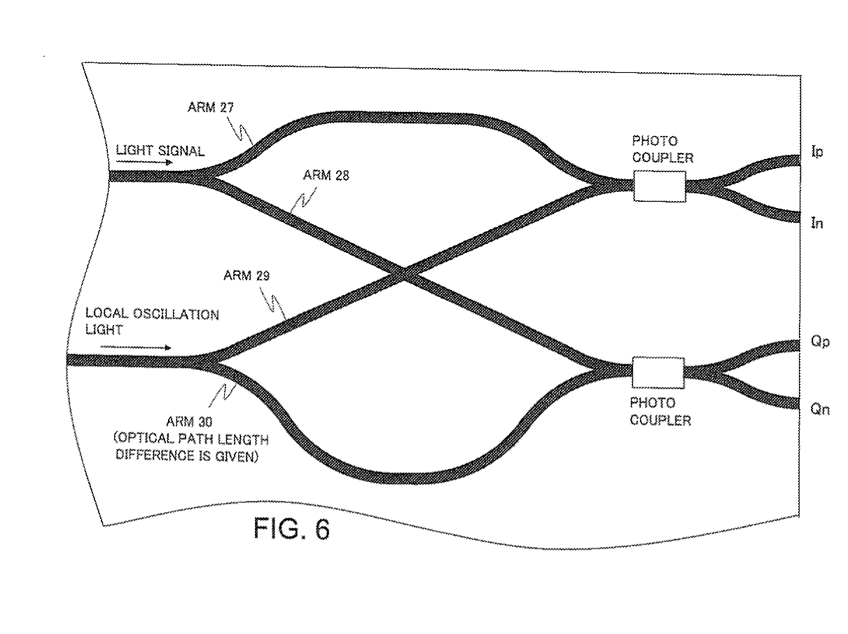

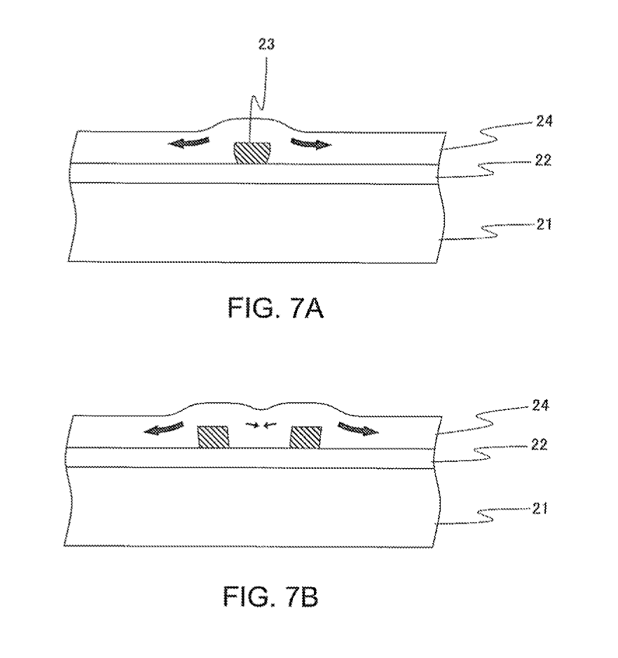

When silicon oxide film or the like is formed on a wafer-like silicon substrate, a warpage occurs to the wafer after heat treatment due to the thermal expansion coefficient difference between the substrate and the film. The stress from the substrate caused by this warpage occurs in the whole wafer, and increases the double refractive index of optical waveguide core. When influence of such stress on the Mach-Zehnder interferometer structure shown in the FIG. 5 is considered, because two optical waveguides 25, 26 are arranged close to each other in the order of a few tens of micro meters, the stress from the substrate is added to the two waveguide portions in the same way. Accordingly, even if the optical path lengths of the optical waveguides 25 and 26 have changed, because the amounts of variations are almost the same and are offset, there is almost no change in the optical path length difference. On the other hand, influence of the stress on the optical coupling strength of the directional coupler parts is not offset in contrast to the optical path length difference, and thus branch ratio fluctuates. In order to avoid this, the film constituting clad needs to be prevented from causing the bimetal effect between the film and the silicon substrate as much as possible. For this reason, impurities such as boron and phosphorus are added to lower the softening temperature of the film and make its thermal expansion coefficient close to that of the substrate.

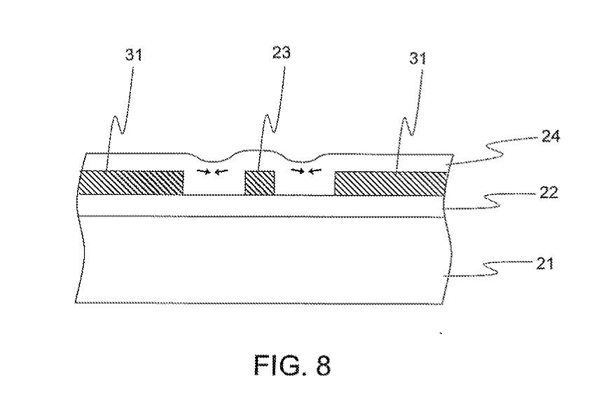

However, of the structure of FIG. 8, most of the optical waveguide core material will remain on the wafer not only as the optical waveguide core 23 but also as the peripheral areas 31 without being etched. GSG (Germanium-Silicate Glass) is generally used as an optical waveguide core material because its refractive index can be easily controlled. Very strong stress of such GSG film leads to wafer warpage in a structure of FIG. 8, which increases double refractive index that cannot be neglected.

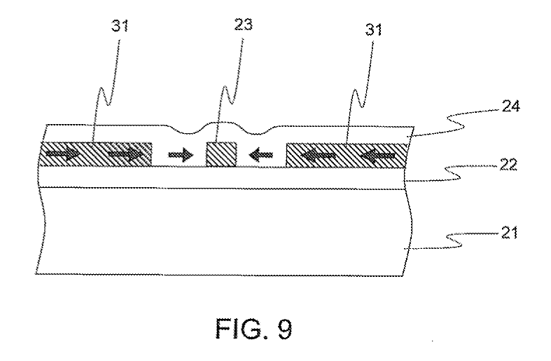

Further, because the volume of the peripheral areas 31 of the optical waveguide core part is large, they expand in heat treatment. Consequently, as shown in FIG. 9, the optical waveguide core part itself undergoes strong influence of stresses (indicated by arrows) from the peripheral areas 31. When the shapes of the peripheral areas 31 around an optical waveguide core are the same, stresses are added equally. However, in actual optical waveguide devices, such case is rare. It is very difficult to predict transformation and the like of core by a stress from the peripheral areas 31 of the optical waveguide core as described above. Therefore, deterioration of the manufacturing yield due to the transformation is difficult to be avoided.

In contrast, an example of the effect of the present invention is to provide an optical waveguide device which enables the stresses from the periphery and the substrate to an optical waveguide core to be reduced, and the fluctuation of an optical path length caused by transformation or double-refractive-index-change of the optical waveguide core to be suppressed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An optical waveguide device comprising:
a lower clad layer formed on a substrate;
an optical waveguide core formed on said lower clad layer;
at least one pair of banks arranged in rows along said optical waveguide core which is arranged between each pair of said banks; and
an upper clad layer covering said optical waveguide core and said banks.

2. The optical waveguide device according to claim 1, wherein each pair of said banks has equal widths and equal distances from said optical waveguide core.

3. The optical waveguide device according to claim 1, wherein all of said banks and said optical waveguide core have equal widths and equal intervals.

4. The optical waveguide device according to any one of claim 1, wherein said banks and said optical waveguide core are formed from the same layer.

5. The optical waveguide device according to claim 1, wherein said banks are separated from said optical waveguide core at least at a distance which does not cause a coupling of light traveling along said optical waveguide core.

6. A manufacturing method of an optical waveguide device, comprising:
forming a lower clad layer on a substrate;
forming an optical waveguide core and at least one pair of banks arranged in rows along said optical waveguide core which is arranged between each pair of said banks, on said lower clad layer; and
forming an upper clad layer covering said optical waveguide core and said banks.

7. The manufacturing method of an optical waveguide device according to claim 6, wherein each pair of said banks has equal widths and equal distances from said optical waveguide core.

8. The manufacturing method of an optical waveguide device according to claim 6, wherein all of said banks and said optical waveguide core have equal widths and equal intervals.

9. The manufacturing method of an optical waveguide device according to claim 6, wherein said banks and said optical waveguide core are formed from the same layer.

10. The manufacturing method of an optical waveguide device according to claim 6, wherein said banks are separated from said optical waveguide core at least at a distance which does not cause a coupling of light traveling along said optical waveguide core.
